(19) United States
(12) Patent Application Publication
(10) Pub. No.: US 2015/0278857 A1
(43) Pub. Date: Oct. 1, 2015

(54) Presenting Offer in Social Context

(71) Applicants: Aimee Moon, Fremont, CA (US); Robert J. Ennals, San Francisco, CA (US); Subramaniam Ganapathy, Mountain View, CA (US); Molly Zellweger Mackinlay, Bellvue, WA (US); David Yu Chen, Sunnyvale, CA (US)

(72) Inventors: Aimee Moon, Fremont, CA (US); Robert J. Ennals, San Francisco, CA (US); Subramaniam Ganapathy, Mountain View, CA (US); Molly Zellweger Mackinlay, Bellvue, WA (US); David Yu Chen, Sunnyvale, CA (US)

(73) Assignee: GOOGLE INC., Mountain View, CA (US)

(21) Appl. No.: 13/548,444

(22) Filed: Jul. 13, 2012

(51) Int. Cl. G06Q 30/02

(52) U.S. Cl. CPC G06Q 30/0252; G06Q 50/01

(57) ABSTRACT

A computer-implemented method for providing an offer in a social context includes: identifying, using one or more processors, an upcoming event comprising a purchasing opportunity that is uniquely associated with a group of users connected to each other in a social network; selecting, using one or more processors, at least one offer based on the identified upcoming event; and presenting the selected at least one offer to at least one of the group of users in the social network in association with the upcoming event.

### TECHNICAL FIELD

This document relates to presenting an offer in a social context.

### BACKGROUND

A person's birthday and other significant events are often celebrated by family and friends. To successfully participate in such celebration by giving a gift, one must first of all be aware that the event is coming up (i.e., so as to not forget about the birthday), second, one must have some more or less specific idea of what the celebrated person would want, and third, one usually tries to avoid choosing the same gift as someone else.

### SUMMARY

In a first aspect, a computer-implemented method for providing an offer in a social context includes: identifying, using one or more processors, an upcoming event comprising a purchasing opportunity that is uniquely associated with a group of users connected to each other in a social network; selecting, using one or more processors, at least one offer based on the identified upcoming event; and presenting the selected at least one offer to at least one of the group of users in the social network in association with the upcoming event.

In a second aspect, a computer program product embodied in a non-transitory computer-readable storage medium includes instructions that when executed by a processor perform a method for providing an offer in a social context. The method includes: identifying, using one or more processors, an upcoming event comprising a purchasing opportunity that is uniquely associated with a group of users connected to each other in a social network; selecting, using one or more processors, at least one offer based on the identified upcoming event; and presenting the selected at least one offer to at least one of the group of users in the social network in association with the upcoming event.

In a third aspect, a system includes: one or more processors; and a computer-readable storage medium having stored therein instructions that when executed by the one or more processors perform a method. The method includes: identifying, using one or more processors, an upcoming event comprising a purchasing opportunity that is uniquely associated with a group of users connected to each other in a social network; selecting, using one or more processors, at least one offer based on the identified upcoming event; and presenting the selected at least one offer to at least one of the users in the social network in association with the upcoming event.

Implementations can include any or all of the following features. The method further includes determining that a first user of the group of users has made a purchase for the upcoming event; and presenting a notification to at least a second user of the group of users in the social network, the notification identifying the determined purchase. The method further includes presenting an input control in the social network, the input control allowing the second user to announce a purchase made regarding the upcoming event. The method further includes presenting an input control in the social network in association with the presented at least one offer, the input control allowing a first user of the group of users to notify at least a second user of the group of users about jointly making a purchase regarding the upcoming event. The method further includes presenting a communication function to the group of users in the social network and announcing the upcoming event, wherein the at least one offer is presented in context of the communication function. The method further includes presenting an input control in the social network in association with the presented at least one offer, the input control allowing a first user of the group of users to notify at least a second user of the group of users of another offer for the identified upcoming event. The upcoming event is an upcoming birthday of a first user of the group of users, and the selected at least one offer is presented to all of the group of users except the first user.

Particular embodiments of the subject matter described in this specification can be implemented to realize one or more of the following advantages. An offer can be selected based on, and presented in context of, a purchasing opportunity detected in a social network. Gift purchasing offers can be presented in a way that reduces the chance of more than one person giving the same gift. Gift purchasing offers can be presented in a way that facilitates two or more people teaming up and jointly buying a more valuable gift.

The details of one or more implementations are set forth in the accompanying drawings and the description below. Other features and advantages will be apparent from the description and drawings, and from the claims.

### DESCRIPTION OF DRAWINGS

FIG. 1 shows an example of a social network interface where an offer is provided in context of a purchasing opportunity.

FIG. 2 shows an example process flow for providing an offer in a social context.

FIG. 3 is a block diagram of a computing system that can be used in connection with computer-implemented methods described in this document.

Like reference symbols in the various drawings indicate like elements.

### DETAILED DESCRIPTION

This document describes systems and techniques by which an offer can be selected based on a social occurrence or other calendar event, and be presented in a social context to inspire a purchase for a particular opportunity. In some implementations, when a person's birthday is coming up, a suitable offer (e.g., a sponsored content item, such as an advertisement) can be selected for that person and presented to the person's social group (e.g., family, friends or contacts on a social site) in a context where they can interact socially with each other. For example, the person's friends can be notified about who is buying what as a birthday gift, and any of the notified people can propose to the others that they should team up and jointly purchase a gift.

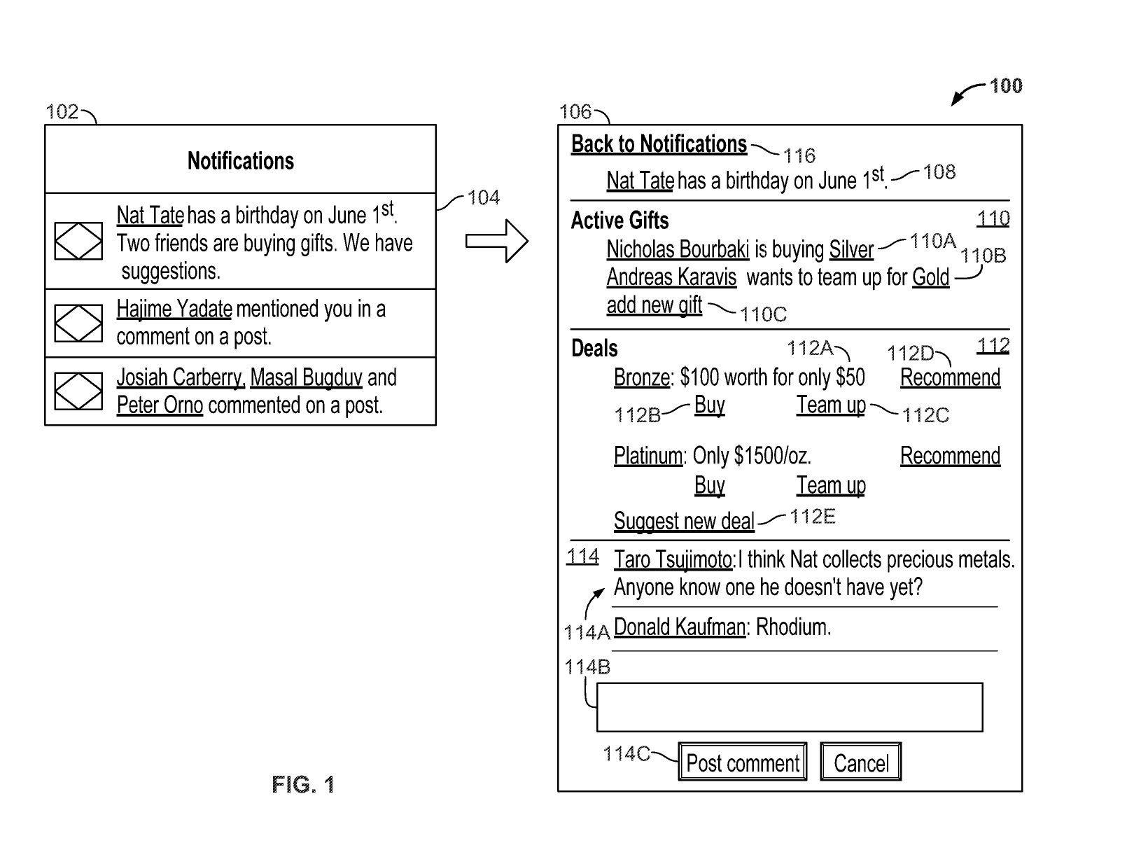

FIG. 1 shows an example of a social network interface 100 where an offer is provided in context of a purchasing opportunity. The social network interface 100 can be presented on any type of device display, screen or monitor. For example, a user who has logged into a social network can be shown at least part of the interface 100 on a smartphone or other handheld device, or on a personal computer.

The social network interface 100 includes a notifications area 102. In some implementations, the notifications area 102 appears in the interface to alert the user about one or more types of events that pertain to the user in some way. For example, the notifications area 102 can alert the user that someone has mentioned the user in a comment, that someone has commented on a post (e.g., a post made by the user or by someone connected to the user), that someone has sent a “acquaintance” request to the user, and/or that one or more calendar events of possible interest to the user is coming up.

In this example, the notifications area 102 includes a birthday notification 104 that states: “Nat Tate has a birthday on June 1st. Two friends are buying gifts. We have suggestions.” In some implementations, these statements have the following background:

Nat Tate has a birthday on June 1st: First, “Nat Tate” is the name of another user who also has an account in the same social network. Nat Tate and the current user are connected to each other in the social network. For example, either or both of them may have sent an acquaintance request to the other, or their connection may have been generated in another way, such as by membership in the same group or at account generation.

Second, upon Nat Tate's registration for an account, or in some other context, the social network may have collected demographic information about Nat Tate, such as the date of birth. Thus, “birthday on June 1st” may here correspond to information obtained from the account record for Nat Tate. In some implementations, information can also or instead be obtained from one or more other sources.

Third, because Nat Tate and the current user are connected in the social network, the birthday notification 104 is generated to alert the user about Nat Tate's upcoming birthday. In some implementations, the social network has defined therein more than one type of connection that can be established between users, and in such situations the birthday notification (or other alert) may be generated only to those people who have a certain type of connection. For example, users who are categorized as Nat Tate's “family,” “relatives” or “acquaintances” may receive the notification, whereas other users—e.g., Nat Tate himself, those labeled as Nat Tate's “acquaintances” or those who are not at all connected to Nat Tate—do not receive the notification.

Two friends are buying gifts: The social network has received confirmation from—in this case two—other users that they are buying a gift for Nat Tate's birthday. For example, those other users may have been prompted to buy gifts by notifications similar to the birthday notification 104. As another example, the other user(s) may have bought (or decided to buy) the gift independently of any notification, but may then have announced the gift through the social network as a way to prompt others to act and/or to avoid that someone buys the same or a very similar gift for the same occasion.

We have suggestions: The upcoming occasion, in this example a birthday, is an occasion for people to socially interact, such as by doing something together and/or perhaps buying gifts. Such situations are opportunities for presenting offers that are relevant to the occasion. In some implementations, one or more offers can be or include an advertisement, such as a gift for a birthday, a restaurant reservation for a wedding anniversary, flower delivery for Mother's Day, or tickets to a sporting event or other cultural performance. That is, suitable offers can be selected based on a particular context, such as that a particular event is coming up (e.g., a birthday) and that two or more people may want to socially interact regarding that event (e.g., purchase gifts). The selected offer(s) can then be presented to one or more of the relevant persons, for example using the social network interface 100.

In some implementations, more information regarding the upcoming event can be presented upon user request. For example, the user can select, click on or otherwise activate the birthday notification 104, which can facilitate further interaction, such as reviewing announced gifts, perusing relevant offers, and/or participating in social interaction regarding the upcoming event.

Here, the social network interface 100 includes an area 106 that lists one or more announced gifts, presents one or more suitable offers, shows social interaction regarding the upcoming event, and allows the user to participate in the social interaction. In some implementations, the area 106 appears after the user clicks on the notification 104.

An announcement 108 in the area 106 can be similar or identical to some or all of the notification 104. For example, the announcement 108 informs the user of the context to which the rest of the information in the area 106 applies; in this example, Nat Tate's upcoming birthday.

An “active gifts” area 110 in the area 106 can identify one or more gifts that have been announced for the occasion of the currently relevant context (here, a birthday). In this example, a first announcement 110A states that “Nicholas Bourbaki is buying Silver.” Here, Nicholas Bourbaki is another person, presumably a friend or relative of Nat Tate's, who has announced that he is buying (or did already buy) “Silver” (i.e., the precious metal) as a gift. Such an announcement may prompt others (e.g., the present user) to also buy gifts or honor the celebrant in some way. As another example, the first announcement 110A can avoid duplicate gifts being given.

A second announcement 110B in the active gifts area 110 states that “Andreas Karavis wants to team up for Gold.” Similarly, Andreas Karavis is presumably a friend or relative who would like to honor Nat Tate's birthday with a gift. However, the announcement 110B seeks to trigger interest in, and coordinate action for, buying a gift collectively, namely “Gold” (i.e., another precious metal). For example, such announcements can facilitate two or more persons in jointly purchasing a gift that may be more valuable than what either of them would have given individually. The second announcement 110B can be interactive, for example so that each user who sees the message and is interested in joining can navigate to a suitable display (not shown) where necessary information can be received and/or entered.

An input control 110C in the active gifts area 110 allows the current user to generate an announcement regarding a gift. In some implementations, the user can “add a new gift” so that others will be notified, such as by messages similar to the first announcement 110A. For example, the user may have bought (or is planning to buy) a certain gift for Nat Tate's birthday, and the input control 110C facilitates notification of others regarding the gift (e.g., to avoid duplication).

A “deals” area 112 in the area 106 can present one or more offers that have been selected for this particular context. Here, a first offer 112A states “Bronze: $100 worth for only $50.” That is, the offer invites the user to purchase “Bronze” (i.e., an alloy) at half the regular price. This offer has been selected based on the current context (e.g., based on information about Nat Tate, the birthday, the circle of friends receiving the offer, etc.) Any suitable recommendation engine can be used for processing relevant context information and choosing one or more relevant offers among those that are available.

An input control 112B is associated with the first offer 112A. In some implementations, the input control 112B allows the current user to take action regarding the presented offer. For example, the user can “buy” the offered item or service. The purchase can then be processed to completion, for example using one or more additional displays (not shown) for specifying the gift more precisely (e.g., by size, amount or model), and/or for choosing shipment or delivery options. Some offers may have a streamlined purchasing procedure that requires relatively little user input at this stage (e.g., because the relevant customer information is already on file with the content provider such as an advertiser, and/or a payment processing agent). Other offers, by contrast, may require the user to input all relevant information after activating the input control 112B.

In some implementations, use of the input control 112B causes a corresponding update of the area 110 for the other users who are to be notified. For example, the area 110 for the other user(s) is then provided with a similar notification of what gift the current user has bought for this event. Also or instead, use of the input control 112B can cause the birthday notification 104 to present a corresponding message. For example, if the current user chooses to buy at least one of the offered items/services, the birthday notification 104 can be updated to instead say “three friends are buying gifts.”

An input control 112C is associated with the first offer 112A. In some implementations, the input control 112C allows the user to prompt one or more other users to collectively purchase a birthday gift. For example, clicking on or otherwise activating the input control 112C can cause a message corresponding to the second announcement 110B to be presented to one or more other users, with the difference that such message will instead identify the item/service of the current offer (here, Bronze). Also or instead, use of the input control 112C can cause the birthday notification 104 to present a corresponding message. For example, if the current user chooses to team up on at least one of the offered items/services, the birthday notification 104 can be updated to instead say “three friends are buying gifts.”

An input control 112D allows the user to inform one or more other people about the offer. In some implementations, the user can “recommend” the offer to friends or others. For example, the input control 112D can function similarly to an endorsement button that is used on a social network or another social site, such as a “+1” button.

Each offer presented in the deals area 112 can have a corresponding one of some or all of the input controls 112B-D. When activated by a user, such button(s) can cause the corresponding action to be taken for that respective offer.

More than one action can be performed. For example, the user can choose to “buy” the offered item/service (i.e., using input control 112B) and also to “recommend” it (i.e., using the input control 112D). As another example, the user can choose to recommend the offered item/service and also to “team up” on it (i.e., using input control 112C). In some implementations, each action taken can be announced to those connected to the user in the social network.

The offers in the deals area 112 are presented to a select group of people in the social network. In some implementations, the offers are presented to those who have performed a specific action regarding the upcoming event. For example, when someone's birthday has been announced in a social network, only those who have recommended the event (e.g., clicked the “+1” or similar button for it), and/or otherwise commented on the event in the social network, are notified about the offers.

The deals area 112 can include an input control 112E that lets the user distribute one or more messages among those notified about the event. In some implementations, the user can “suggest [a] new deal” to the other people. For example, the user may know of another possible gift (for example) that the user thinks is a better choice than the offer(s) listed in the deals area. The user can then alert the others about this deal using the input control 112E.

The area 106 can include a social interaction area 114. In some implementations, the social interaction area 114 lets one or more of those notified about the occasion socially interact regarding the event. For example, the social interaction can discuss planning for a surprise party, the address for sending a gift or other message to the celebrant, and/or the specific gifts that are being considered. The deals area 112 presents the offer(s) in the context where the users can socially interact about the offer(s).

The users can engage in one or more forms of social interaction using the social network interface 100. In some implementations, the social interaction can be written (e.g., by a chat or other messaging function), spoken (e.g., by an audio interface that lets two or more people talk with each other) and/or audiovisual (e.g., by videoconference).

Here, a chat communication 114A between two people regarding the present event is presented. An input control 114B lets the user participate in the conversation, such as by typing a reply and/or another question. A “post comment” control 114C causes the user's message to be presented to the other notified users.

The area 106 can remain visible for a specified or unspecified period of time. In some implementations, one or more specified actions can cause the area 106 to disappear. For example, a “back to notifications” control 116 can be used to close the area 106.

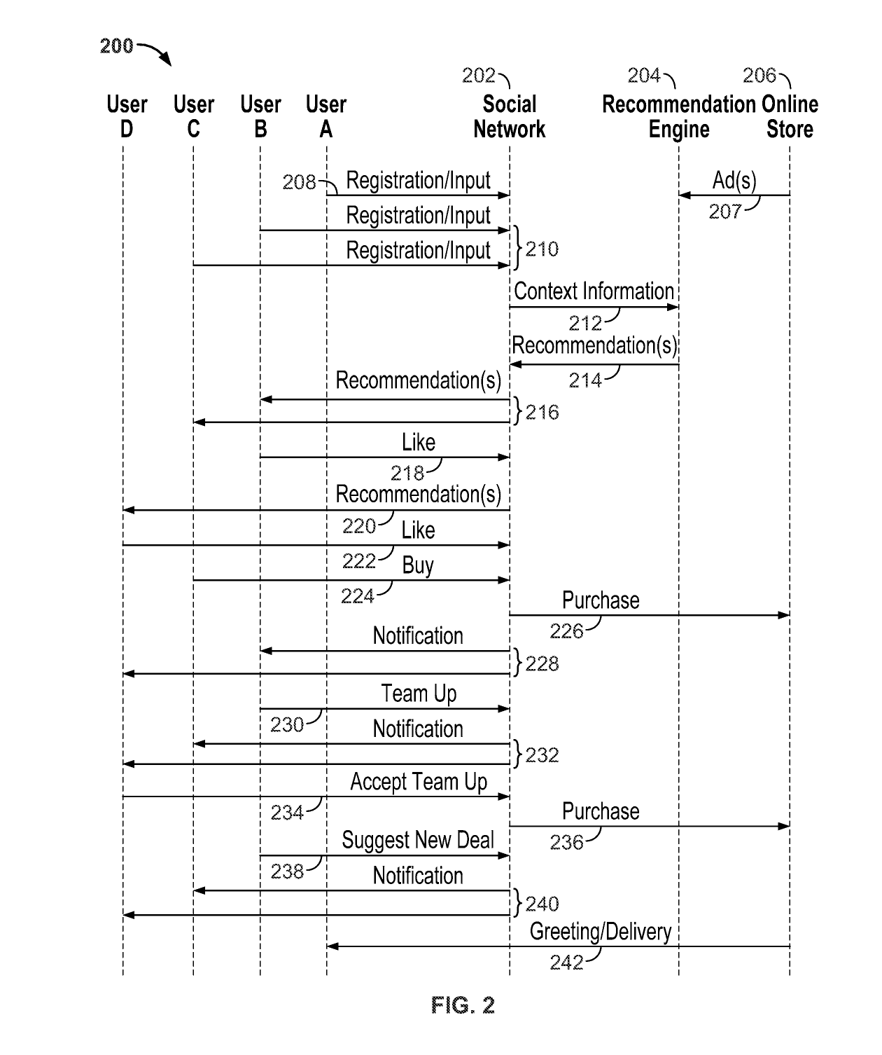

FIG. 2 shows an example process flow 200 for providing an offer in a social context. In some implementations, the process flow can be performed by processor-based execution of instructions in one or more systems. For example, the process flow can be performed in the system(s) generating the social network interface 100 (FIG. 1).

The process flow 200 involves at least one social network 202. For example, this can include any social network or other social site. The social network 202 can be generated using one or more systems (e.g., servers). The social network 202 has registered therein accounts for individuals, organizations, companies, etc., who wish to interact with others and/or share information in the social network. For clarity, the present example shows only four users (labeled user A, B, C and D, respectively) as being connected to the social network. In some implementations, the social network 202 is capable of registering accounts for an essentially unlimited number of users.

The process flow 200 involves at least one recommendation engine 204. In some implementations, this can include any system that can analyze or otherwise process context information and thereby choose at least one recommendation from among available ones, can be used in the recommendation engine 204.

The process flow 200 involves at least one online store 206. For example, the online store is operated by an advertiser who wishes to have its one or more advertisements presented in a suitable context where people are socially interacting regarding particular events. Therefore, one or more advertisements can be provided to the recommendation engine 204 at 207. In some implementations, the process flow 200 can also or instead involve one or more stores or other vendors who do not conduct business online.

At 208, the user A makes a registration or other input to the social network 202. For example, the user A signs up as a member of the social network, provides the required information, and is assigned an account number or other membership identifier. As another example, the user A is already a registered account holder with the social network and is currently typing some information in a post or other entry, such as “tomorrow is my birthday,” “I just got promoted” or “I graduate from college next week”. This and/or other relevant information about the user A can be registered by the social network 202 and used in providing suitable recommendations to friends and others.

Storing of personal information is done in compliance with applicable laws and rules regarding privacy protection. One or more preventative measures can be taken to reduce the risk of unauthorized access to and use of the stored information. For example, information can be encrypted, and/or anonymized using a unique identifier for each user. As another example, an opt-out procedure can be provided so that users who do not want to be subject to this form of offer presentation can nevertheless participate in the social network, or the offer presentation can be performed only with regard to those users who have actively opted in.

Likewise, at 210 users B and/or C make registrations and/or other inputs to the social network 202. For example, the users A, B and C are now registered as “acquaintances” with each other in the social network 202.

At this time, the social network has access to specific information, including the date of an event (e.g., user A's birthday) and the “acquaintance” connections between users A, B and C. The social network may also have registered other information, such as particular hobbies or other interests for each of the users. Collectively, this information can be considered “context information” regarding the upcoming event, because it indicates a purchasing opportunity that involves multiple users connected to each other in a social network.

At 212, the social network 202 provides some or all of the context information to the recommendation engine 204 to choose one or more suitable offers. In some implementations, the context information is provided just before one or more offers should be presented. For example, the social network 202 may have a rule that birthday announcements regarding possible gifts, etc. should begin one week before the birthday. Therefore, when any of the users B or C logs into the social network, it can be determined whether any of their friends has a significant event (e.g., a birthday) coming up in one week or less. If so, the social network can provide the most current context information to the recommendation engine at the time of login.

At 214, the recommendation engine 204 provides the selected recommendation(s) to the social network. For example, this may be in form of one or more ads to be presented. The social network can provide the selected recommendation(s) to the users at 216, for example as the first offer 112A (FIG. 1). The selected offer(s) can be presented in the context of the announcement regarding the birthday (or other event). That is, at this time, the users B and C are the only ones notified about the birthday recommendations in this example. For example, the users B and C are the ones currently listed as being “family” of user A in the social network. In some implementations, the recommendation(s) can be sent directly to the user B, C, etc. and not via the server(s) of the social network 202.

At 216, the user B “likes” the birthday announcement. For example, this can be done using input control 112D (FIG. 1). As a result, at 220 one or more recommendations can be made to all of user B's friends—here represented by user D. For example, the recommendation can say: “User B likes user A's birthday in one week.” At 222, the user D in this example posts a “like” or other comment regarding the birthday announcement. As noted above, this action can serve to include the user D in the group of users notified about the birthday. For example, clicking a “+1” button or otherwise commenting on an event can cause the person to be notified about opportunities regarding this event, the notification being done in a context where the user can socially interact with others regarding the event and/or gifts, etc.

At 224, the user C announces that a certain gift has been (or will be) bought for this particular event. For example, this announcement can be done using the input control 110C (e.g., “add new gift”), and/or upon activation of the input control 112B (e.g., “buy”), in FIG. 1. The social network 202 can inform the online store 206 about the purchase at 226 so that the store can process the purchase accordingly and arrange for delivery and/or other performance. In some implementations, the “buy” instruction can be sent from the user (e.g., from a computer or other device) to the online store without involving the social network. For example, the user clicks on a link that leads directly to the online store. The online store can send a confirmation (not shown) to the social network and/or to the user that the purchase has been registered.

At 228, the social network 202 notifies one or more users about user C's purchase. For example, users B and D are here notified. In some implementations, this can be done using the birthday notification 104 (e.g., “Two friends are buying gifts”) and/or the first announcement 110A (e.g., “Nicholas Bourbaki is buying Silver”) in FIG. 1.

At 230, user B issues an invitation to team up to buy a gift, and this is received by the social network 202. For example, this can be done with input control 112C (FIG. 1). At 232, the social network can notify one or more other users about this invitation. In some implementations, this is done using the birthday notification 104 and/or the second announcement 110B (e.g., “Andreas Karavis wants to team up for Gold”) in FIG. 1.

At 234, the user D accepts user B's invitation to team up in buying a gift. In some implementations, this acceptance is generated by interacting with (e.g., clicking on) the second announcement 110B in FIG. 1. For example, the acceptance can imply that the cost of the selected gift (in this example, “Gold”) will be shared between users B and D and any other users (not shown) who have also accepted user B's invitation. At 236, the online store 206 can be notified about this team purchase.

The notification at 236 can be sent upon occurrence of a particular event. For example, the user B sets an expiration date for the “team up” invitation (e.g., based on the estimated shipping time for this particular gift), and when the time expires, the purchase is carried out if at least a minimum number of users have teamed up (e.g., a threshold defined by user B). As another example, the user B sets a maximum number of participants in the collective purchase, and if and when that number is reached, the purchase is carried out and the invitation is thereafter withdrawn.

At 238, the user B suggests a new deal, and this is received by the social network 202. In some implementations, this can be done using the input control 112E (FIG. 1). For example, user B may have discovered another gift that he or she thinks user A would appreciate, and wants to tip others about this opportunity. The others (here users C and D) can be notified at 240 about the newly suggested deal, and may have the opportunity to either purchase that item/service, and/or to propose a collective purchase, in analogy with the description above.

At 242, the online store 206 can forward a greeting and/or gift delivery to the user A based on the purchase(s) made by those participating in this social interaction. While not explicitly illustrated here, it will be understood that any or all of the users B, C and D can engage in social interaction (e.g., using the area 114 in FIG. 1) at one or more times during the process flow 200.

The recommendation engine 204 can generate updated recommendations at one or more times. For example, whenever the social network 202 updates its interface (e.g., refreshes a display screen) to any of the users B, C or D, the social network can also prompt the recommendation engine for updated recommendations (not shown) that can be provided to the user(s). Such recommendation(s) can be selected using the most up-to-date context information available to the social network. For example, information in the chat communication 114A (FIG. 1) can be used to make further suggestions for offers that may be of interest.

The following are examples of how a social network (e.g., the social network 202) and a recommendation engine (e.g., the recommendation engine 204) can communicate. In some implementations, the social network can provide one or more keywords based on information that a person (e.g., the birthday person) has shared with all friends. For example, such information may have been provided in a social-network profile or in post content, and can indicate one or more interests. The keywords that are provided can be directly obtained from the available information, or can indicate one or more categories (e.g., chemistry or precious metals), to name just a few examples.

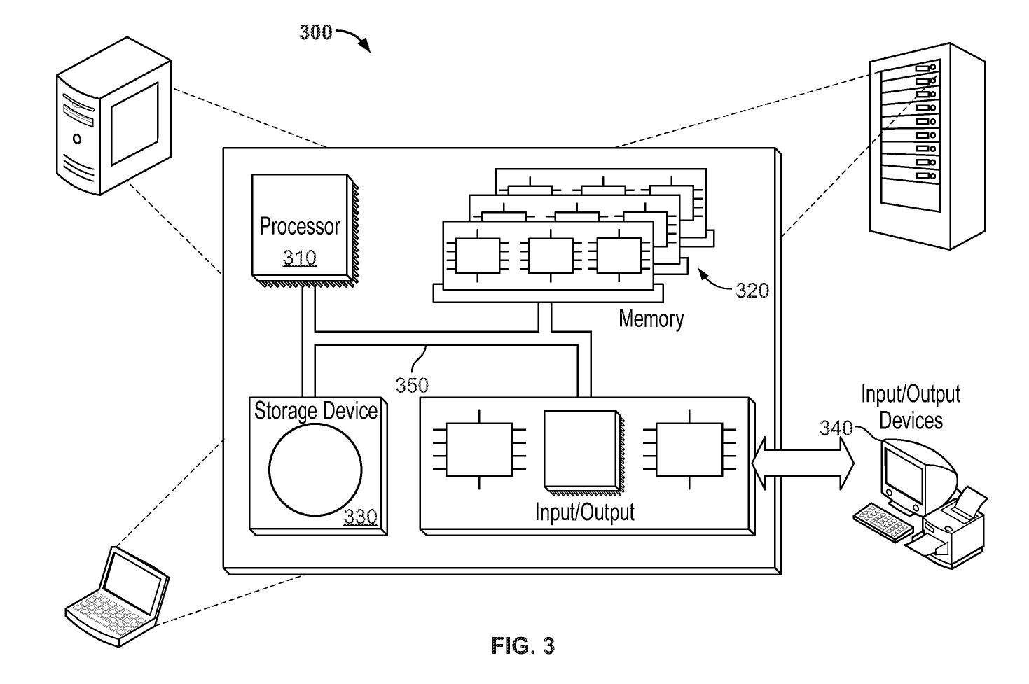

FIG. 3 is a schematic diagram of a generic computer system 300. The system 300 can be used for the operations described in association with any of the computer-implement methods described previously, according to one implementation. The system 300 includes a processor 310, a memory 320, a storage device 330, and an input/output device 330. Each of the components 310, 320, 330, and 330 are interconnected using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330 to display graphical information for a user interface on the input/output device 330.

The memory 320 stores information within the system 300. In some implementations, the memory 320 is a computer-readable medium. The memory 320 is a volatile memory unit in some implementations and is a non-volatile memory unit in other implementations.

The storage device 330 is capable of providing mass storage for the system 300. In one implementation, the storage device 330 is a computer-readable medium. In various different implementations, the storage device 330 may be a floppy disk device, a hard disk device, an optical disk device, or a tape device.

The input/output device 330 provides input/output operations for the system 300. In one implementation, the input/output device 330 includes a keyboard and/or pointing device. In another implementation, the input/output device 330 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

1. A computer-implemented method for providing an offer in a social context, the method comprising:
for a particular group of users connected to each other in a social network, identifying, using one or more processors, an upcoming event occurring within a predefined period of time, wherein the upcoming event is associated with a particular user of the group of users and comprises a purchasing opportunity that is uniquely associated with the particular user;
selecting, using one or more processors, at least one offer based on the identified upcoming event and specific context information associated with the particular user including interests of the particular user;
for each user of one or more users of the group:
providing a notification of the upcoming event in a notification interface, wherein the notification interface simultaneously displays one or more social network notifications and an alert of the upcoming event, wherein the one or more social network notifications are unrelated to the upcoming event;
receiving a user selection of the presented notification; and
presenting a user interface associated with the upcoming event to respective users of the group of users in response to the user selection of the presented notification, the user interface including:
a first region for presenting information on active gifts associated with the upcoming event from users of the group of users,
a second region for presenting the at least one offer, wherein the at least one offer is an advertisement, the particular advertisement being associated with content relevant to the upcoming event, and
a third region for presenting communications posted by users of the group of users in response to the presented user interface.

2. The computer-implemented method of claim 1, further comprising:
determining that a first user of the group of users has made a purchase for the upcoming event; and
presenting a notification to at least a second user of the group of users in the social network, the notification identifying the determined purchase.

3. The computer-implemented method of claim 2, further comprising presenting an input control in the user interface, the input control allowing the second user to announce a purchase made regarding the upcoming event.

4. The computer-implemented method of claim 1, further comprising presenting an input control in the user interface in association with the presented at least one offer, the input control allowing a first user of the group of users to notify at least a second user of the group of users about jointly making a purchase regarding the upcoming event.

5. The computer-implemented method of claim 1, further comprising presenting a communication function to the group of users in the social network and announcing the upcoming event, wherein the at least one offer is presented in context of the communication function.

6. The computer-implemented method of claim 1, further comprising presenting an input control in the user interface in association with the presented at least one offer, the input control allowing a first user of the group of users to notify at least a second user of the group of users of another offer for the identified upcoming event.

7. The computer-implemented method of claim 1, wherein the upcoming event is an upcoming birthday of the particular user of the group of users, and wherein the selected at least one offer is presented to all of the group of users except the particular user.

8. A computer program product embodied in a non-transitory computer-readable storage medium and comprising instructions that when executed by a processor perform a method for providing an offer in a social context, the method comprising:
for a particular group of users connected to each other in a social network, identifying, using one or more processors, an upcoming event occurring within a predefined period of time, wherein the upcoming event is associated with a particular user of the group of users and comprises a purchasing opportunity that is uniquely associated with the particular user;
selecting, using one or more processors, at least one offer based on the identified upcoming event and specific context information associated with the particular user including interests of the particular user;
for each user of one or more users of the group:
providing a notification of the upcoming event in a notification interface, wherein the notification interface simultaneously displays one or more social network notifications and an alert of the upcoming event, wherein the one or more social network notifications are unrelated to the upcoming event;
presenting a user interface associated with the upcoming event to respective users of the group of users in response to the user selection of the presented notification, the user interface including:
a first region for presenting information on active gifts associated with the upcoming event from users of the group of users,
a second region for presenting the at least one offer, wherein the at least one offer is an advertisement, the particular advertisement being associated with content relevant to the upcoming event, and
a third region for presenting communications posted by users of the group of users in response to the presented user interface.

9. The computer program product of claim 8, the method further comprising:
determining that a first user of the group of users has made a purchase for the upcoming event; and
presenting a notification to at least a second user of the group of users in the social network, the notification identifying the determined purchase.

10. The computer program product of claim 9, the method further comprising presenting an input control in the user interface, the input control allowing the second user to announce a purchase made regarding the upcoming event.

11. The computer program product of claim 8, the method further comprising presenting an input control in the user interface in association with the presented at least one offer, the input control allowing a first user of the group of users to notify at least a second user of the group of users about jointly making a purchase regarding the upcoming event.

12. The computer program product of claim 8, the method further comprising presenting a communication function to the group of users in the social network and announcing the upcoming event, wherein the at least one offer is presented in context of the communication function.

13. The computer program product of claim 8, the method further comprising presenting an input control in the user interface in association with the presented at least one offer, the input control allowing a first user of the group of users to notify at least a second user of the group of users of another offer for the identified upcoming event.

14. The computer program product of claim 8, wherein the upcoming event is an upcoming birthday of the particular user of the group of users, and wherein the selected at least one offer is presented to all of the group of users except the particular user.

15. A system comprising:
one or more processors; and
a computer-readable storage medium having stored therein instructions that when executed by the one or more processors perform a method comprising:
for a particular group of users connected to each other in a social network, identifying, using one or more processors, an upcoming event occurring within a predefined period of time, wherein the upcoming event is associated with a particular user of the group of users and comprises a purchasing opportunity that is uniquely associated with the particular user;
selecting, using one or more processors, at least one offer based on the identified upcoming event and specific context information associated with the particular user including interests of the particular user;
for each user of one or more users of the group:
providing a notification of the upcoming event in a notification interface, wherein the notification interface simultaneously displays one or more social network notifications and an alert of the upcoming event, wherein the one or more social network notifications are unrelated to the upcoming event;
presenting a user interface associated with the upcoming event to respective users of the group of users in response to the user selection of the presented notification, the user interface including:
a first region for presenting information on active gifts associated with the upcoming event from users of the group of users,
a second region for presenting the at least one offer, wherein the at least one offer is an advertisement, the particular advertisement being associated with content relevant to the upcoming event, and
a third region for presenting communications posted by users of the group of users in response to the presented user interface.

16. The system of claim 15, the method further comprising:
determining that a first user of the group of users has made a purchase for the upcoming event; and
presenting a notification to at least a second user of the group of users in the social network, the notification identifying the determined purchase.

17. The system of claim 16, the method further comprising presenting an input control in the user interface, the input control allowing the second user to announce a purchase made regarding the upcoming event.

18. The system of claim 15, the method further comprising presenting an input control in the user interface in association with the presented at least one offer, the input control allowing a first user of the group of users to notify at least a second user of the group of users about jointly making a purchase regarding the upcoming event.

19. The system of claim 15, the method further comprising presenting a communication function to the group of users in the social network and announcing the upcoming event, wherein the at least one offer is presented in context of the communication function.

20. The system of claim 15, the method further comprising presenting an input control in the user interface in association with the presented at least one offer, the input control allowing a first user of the group of users to notify at least a second user of the group of users of another offer for the identified upcoming event.

21. The method of claim 1, wherein the notification is provided to one or more users of the group of users having a specified relationship to the particular user in the social network.
